(19) United States
(12) Patent Application Publication
(10) Pub. No.: US 2025/0329761 A1
(43) Pub. Date: Oct. 23, 2025

(54) INTERMITTENT EXHAUST GAS RECIRCULATION DURING OPERATION OF A FUEL CELL SYSTEM

(71) Applicant: Robert Bosch GmbH, Stuttgart (DE)

(72) Inventor: Jochen Braun, Heimsheim (DE)

(21) Appl. No.: 18/870,814

(22) PCT Filed: Jun. 16, 2023
(86) PCT No.: PCT/EP2023/066293

§ 371 Date: Dec. 2, 2024

(30) Foreign Application Priority Data
Jun. 22, 2022 (DE) 10 2022 206 229.9

(51) Int. Cl. H01M 8/04746; H01M 8/04082; H01M 8/04111; H01M 8/04119; H01M 8/04223; H01M 8/0438; H01M 8/04492; H01M 8/04537

(52) U.S. Cl. CPC H01M 8/04761; H01M 8/04111; H01M 8/04141; H01M 8/04179; H01M 8/04201; H01M 8/04231; H01M 8/0441; H01M 8/04492; H01M 8/04619

(57) ABSTRACT

The invention relates to a method for operating a fuel cell system (100),
wherein the fuel cell system (100) comprises the following components:
   at least one fuel cell stack (101), and
   a cathode system (10) for supplying a reactant containing oxygen to the at least one fuel cell stack (101) in the form of supply air (L1),
wherein the cathode system (10) comprises the following components:
   at least one supply air line (11) for supplying supply air (L1) to the at least one fuel cell stack (101)
   and at least one exhaust line (12) for discharging exhaust air (L2) from the at least one fuel cell stack (101),
   wherein a compression unit (KE) is provided in the at least one supply air line (11) for compressing supply air (L1),
   wherein an air connection (LV) is provided from an exhaust air (L2) to supply air (L1) between the at least one exhaust line (12) and the at least one supply air line (11) of the cathode path (10),
   and wherein the air connection (LV) is used to provide intermittent exhaust gas recirculation (EGR) into the supply air (L1) in at least one operating mode (M) of the fuel cell system (100).

### BACKGROUND

The invention relates to a method for operating a fuel cell system. The invention further relates to a computer program product, a control unit, and a fuel cell system.

In drive systems with fuel cell systems, oxygen from the ambient air is typically used to react with hydrogen in the fuel cell to create water or water vapor and thereby generate an electrical energy. The ambient air is supplied to the fuel cell stack by means of a conveyor system or compression system. The compression system is designed to provide a particular mass air flow rate and/or a particular pressure level. The compression of the supply air is often performed by a thermal turbomachine (single stage, multi-stage, or multi-flow). Optionally, energy recovery of the downstream moist exhaust air can be realized by means of a turbine (e.g., electrically driven turbocharger or turbocharger without an electric drive) for air compression. Higher system pressures (e.g., to allow for higher-performance fuel cell systems) can be achieved by two-stage compression and energy recuperation using a turbine.

In some systems, the supply air is humidified by means of a humidifier. A humidifier requires installation space and causes a loss of pressure. In other systems, internal humidification of the stack is provided without a separate humidifier for the supply air. For this purpose, the membrane in the stack is designed to be thin, such that wetting of the membrane is performed by means of the product water resulting in the cathode path and internal stack interactions with the anode path and its recirculation. Internal humidification is limited with respect operating ranges, particularly in the high-load range or at elevated stack temperatures.

### SUMMARY

According to the first aspect, the invention provides a method for operating a fuel cell system having the features of the disclosure. According to the second aspect, the invention also provides a computer program product, a control unit, and a fuel cell system having the features of the disclosure. Further features, advantages, and details of the invention arise from the dependent claims, the description, and the drawings. In this context, features and details described in connection with individual aspects according to the invention clearly also apply in connection with the other aspects according to the invention, and respectively vice versa so that, with respect to the disclosure, mutual reference to the individual aspects of the invention is or can always be made.

The present invention provides a method for operating a fuel cell system,
whereby the fuel cell system comprises the following components:
   at least one fuel cell stack, and
   a cathode system for providing a reactant containing oxygen to the at least one fuel cell stack in the form of supply air,
whereby the cathode system comprises the following components:
   (at least) one supply air line for providing the supply air to the at least one fuel cell stack
   and (at least) an exhaust line for discharging exhaust air from the at least one fuel cell stack,
whereby a compression unit for compressing supply air is provided in the (at least one) supply air line,
whereby an air connection (from one stack_i to the same stack_i, from stack_i to another stack_k, from multiple stacks_i,j to one and/or multiple same or different stacks_k,m, whereby i, j, k, m can be the same or different counters) is provided between the (at least one) exhaust line and the (at least one) supply air line of a specific cathode path,
and whereby the air connection is used to provide an intermittent exhaust gas recirculation in the (meaning corresponding) supply air in at least one mode of operation of the fuel cell system.

The fuel cell system within the scope of the invention can comprise at least two or more fuel cell stacks (abbreviated as “stacks”), each having a plurality of stacked repeat units in the form of fuel cells, e.g. PEM fuel cells.

The fuel cell system within the scope of the invention can advantageously be used for mobile applications, e.g. in motor vehicles, or for stationary applications, e.g. in generator systems.

The fuel cell system within the scope of the invention can advantageously comprise a control unit which is designed to control the cathode system, in particular to control the compression unit and preferably to control the intermittent exhaust gas recirculation according to the inventive method.

The cathode system within the scope of the invention can also be referred to as an air system.

The compression unit within the scope of the invention can also be referred to as an air compression system. The compression unit within the scope of the invention can comprise at least one compressor, whereby the at least one compressor can be electromotive, e.g. driven by an electric motor, and/or mechanically driven, preferably using a turbine or turbocharger. At least one compressor can further be single stage, two stage, or dual flow. Further, the compression unit can comprise at least one turbine to support at least one compressor.

The air connection within the scope of the invention can preferably be a line between the (at least one) exhaust line and the (at least one) supply air line (from one stack_i to the same stack_i, from stack_i to another stack_k, from multiple stacks_i,j to one and/or multiple same or different stacks_k,m, whereby i, j, k, m can be the same or different counters) as well as a recirculation valve.

Exhaust gas recirculation in the context of the invention can be abbreviated as EGR.

The core of the idea is to provide an intermittent operational strategy for exhaust gas recirculation which can, e.g., be beneficial in a continuous high-load range or in other load ranges of the system. The intermittent exhaust gas recirculation can provide variable activation of operating parameters of the fuel cell system, in particular the cathode system. The intermittent exhaust gas recirculation can further optionally be combined with a corresponding activation of an anode system and/or cooling system.

Using the intermittent exhaust gas recirculation, it can be ensured that the at least one fuel cell stack:
neither dries out (in the entry areas of the stack cathode) nor
is flooded (near or at the exit areas of the stack cathode)
and can continuously produce the high load or maximum load.

In particular, the following (other optional) parameters can be varied:
cathode pressure,
cathode mass flow rate,
cathode outlet activity, and
EGR recirculation rate (thus also cathode inlet moisture).

Multiple advantages can be achieved using the invention:
temporary humidification of the supply air at the entry into the stack, without a loss of power or derating,
temporary improvement of the removal of water from the exit of the stack,
temporary oxygen depletion in the stack,
improvement in stack service life,
decrease in stack degradation (less drying, etc.)
cost savings in the system design, etc.

For example, intermittent exhaust gas recirculation can be advantageous for high-load operation (e.g. 50%-100%, in particular 75%-100% or even 80%-100% of the maximum output), in particular continuous high-load operation, and/or maximum load operation of the fuel cell system. The term “continuous” can mean that the system is subject to a high-load or a maximum load request to the fuel cell system for long enough that:
purely stack-internal humidification can no longer be maintained and/or
this use case would already lead to a more costly design (enlargement of the stack or the air system) during development.

Furthermore, intermittent exhaust gas recirculation can be advantageous at low loads, e.g. if the supply air mass flow rate is low enough that the discharge of waste water from the stack is insufficient and that there is a risk of liquid water accumulating in the stack and/or the stack being flooded. However, if the mass flow rate of fresh air is increased, then the oxygen in the cathode can also increase, which may lead to insufficient power and water management. Using the intermittent exhaust gas recirculation, the discharge of water can be enabled, preferably without the stack simultaneously increasing the oxygen mass in the cathode path. Advantageously, the cathode pressure can thereby remain substantially constant.

During normal operation, initially only in-stack humidification can be performed without intermittent exhaust gas recirculation. If high ambient temperatures prevail in normal operation, resulting in high stack temperatures, but the temperature difference to the surrounding environment is still sufficient to sufficiently remove the waste heat from the stack, then the stack must be operated at high pressure pCath1 and low combustion air ratio lambdaCath1 (or lambda, which is also abbreviated as y, air ratio, or air count and is superstoichiometrically expressed as mCathStack=lambda*mCathStoechiometric) in order to maintain in-stack humidification. In this case, the entry/initial areas of the stack cathode can be at risk of drying out (drying of the membrane) after a certain time td1. The output/end areas of the stack cathode may in turn run the risk of partial flooding due to high water production at high load after a certain time td2. Both effects can lead to performance declines and in some cases also to degradation of the stack. Advantageously, intermittent exhaust gas recirculation can be initiated after a time tS10=min (td1, td2).

Intermittent exhaust gas recirculation may preferably comprise in-stack humidification and additionally exhaust gas recirculation.

Intermittent exhaust gas recirculation can then be initiated or triggered when the time tS10=min (td1, td2) has elapsed.

Advantageously, intermittent exhaust gas recirculation causes no, or at least no substantial, reduction in performance.

A CVRezi recirculation valve can be opened in the partial position to introduce a portion of the exhaust air into the supply air for intermittent exhaust gas recirculation.

The cathode pressure is lowered to pCath2 and the mass flow rate is increased mCath2 in this case. The activity at the cathode outlet actCath2 also temporarily increases.

In other words, the air in the cathode removes more water, and humidification of the supply air is improved.

By increasing the mass flow rate in the stack, the water in the output/end areas is conveyed out better, meaning that the risk of flooding is significantly reduced.

The increased mass flow rate advantageously does not increase the lambda in the cathode, because the supplied exhaust air is lower in oxygen than the mass air flow from the surrounding area. The lambda can preferably be kept approximately the same if the air system additionally increases the supply air quantity somewhat. This is possible even if the air system no longer has a rotational speed reserve because, by decreasing the system pressure (in the cathode), the air system can deliver a greater mass flow rate at the same rotational speed. Alternatively or additionally, a rotational speed reserve can be provided in the air system.

By humidifying via the air connection between the exhaust air and the supply air using the intermittent exhaust gas recirculation, the entry areas of the stack in particular can be significantly humidified so that the risk of the membrane drying out can be significantly reduced.

The intermittent exhaust gas recirculation can be performed for a certain time tS20. The time tS20 can vary as a function of various effects, such as humidification at the cathode inlet tx1, reduction in flooding tx2, optionally permissible duration of lambda decrease tx3, e.g. tS20=min(max(tx1,tx2), tx3).

The intermittent exhaust gas recirculation can use different types of activation (different times on or off, different gradients, etc.). Different types of actuation can be determined individually, depending on the system, and/or depending on design, and/or operating conditions, and/or depending on boundary conditions.

Also, the essential parameters can be adjusted constantly or variably during the phases (intermittent exhaust gas recirculation on and off).

Intermittent exhaust gas recirculation can continue to be performed proactively, for example, with trajectory planning and/or as a function of weather data, navigational data, predicted performance trajectories, etc.

As already mentioned above, intermittent exhaust gas recirculation can be performed in an advantageous manner during high-load operation and/or a maximum-load operation, particularly continuous high-load and/or maximum-load operation of the fuel cell system in order to in humidify the supply air in particular, preferably under high ambient temperatures.

As already mentioned above, intermittent exhaust gas recirculation can also be used to increase the mass flow rate through the at least one fuel cell stack, in particular to assist in removing water from the fuel cell stack, preferably without increasing the oxygen mass in the at least one fuel cell stack, and preferably without altering a cathode pressure.

Advantageously, intermittent exhaust gas recirculation can also be utilized to reduce oxygen in a mass flow through the at least one fuel cell stack.

Intermittent exhaust gas recirculation can provide for an opening, in particular a partial opening, of a recirculation valve for the sake of simplicity. In this way, a portion of the exhaust air can be introduced into the supply air.

Further, intermittent exhaust gas recirculation can provide for variable activation of at least one operating parameter of the fuel cell system, in particular the cathode system, based on the following parameters, such as:
a rate of recirculation from the exhaust to the supply air,
cathode mass flow rate,
cathode pressure, and/or
cathode activity.

Furthermore, intermittent exhaust gas recirculation can provide for periodic or aperiodic and/or symmetric or asymmetric activation of at least one operating parameter of the cathode system. In this way, flexible functionality can be provided.

Furthermore, it is possible that intermittent exhaust gas recirculation can be initiated when:
internal humidification of the at least one fuel cell stack is not sufficient,
entry areas/initial areas of the at least one fuel cell stack dry out or are likely to be at risk of drying out, particularly after a certain time, and/or
output areas/end areas of the at least one fuel cell stack can be flooded or are likely to be flooded, particularly after a certain time,
in the case of longer exposure to high-load requirements on the at least one fuel cell stack,
whereby in particular a stack voltage and/or single cell voltages and/or impedance are measured to detect the state of the fuel cell stack and/or a potential for danger, drying, flooding, etc. in the fuel cell stack,
oxygen depletion, at least on a temporary basis, is required in the at least one fuel cell stack.

According to a further advantage, intermittent exhaust gas recirculation can be performed repeatedly and/or regularly, and/or due to specific events and/or periodically. In this way, flexible as well as extended functionality can be provided.

In addition, it can be advantageous if intermittent exhaust gas recirculation is performed in a proactive manner, in particular as a function of weather data and/or navigation data. In this way, the requirements of the system can be considered in a manner that is particularly protective for the system as well as particularly targeted, e.g., from the point of view of water management.

Furthermore, the invention provides: a computer program product comprising commands which, when the computer program product is executed by a computer, cause it to perform a method which can proceed as described above. The same advantages can be achieved using the computer program product according to the invention as described above in connection with the method according to the invention. In the present case, reference to these advantages is made in full.

Furthermore, the invention provides: a control unit comprising a computing unit and a storage unit in which a code is stored, which, when at least partially executed by the computing unit, performs a method which can proceed as described above. The same advantages can be achieved using the control unit according to the invention as described above in connection with the method according to the invention. In the present case, reference to these advantages is made in full.

Furthermore, the invention provides: a fuel cell system, whereby the fuel cell system comprises the following components:
at least one fuel cell stack, and
a cathode system for providing a reactant containing oxygen to the at least one fuel cell stack in the form of supply air,
whereby the cathode system comprises the following components:
(at least) one supply air line for delivering the supply air to the at least one fuel cell stack
and (at least) an exhaust line for discharging exhaust air from the at least one fuel cell stack,
whereby a compression unit for compressing a supply air is provided in the (at least one) supply air line,
whereby an air connection is provided between an exhaust and a supply air (from one stack i to the same stack_i, from stack_i to another stack_k, from multiple stacks_i,j to one and/or multiple same or different stacks_k,m, whereby i, j, k, m are the same or different counters) between the (at least one) exhaust line and the (at least one) supply line,
and whereby the air connection is arranged to provide an intermittent exhaust gas recirculation into the supply air in at least one mode of operation of the fuel cell system.

In addition, it can be advantageous for a control unit to be provided in the fuel cell system that is designed to perform a method which can proceed as described above.

The same advantages can be achieved using the fuel cell system according to the invention as described above in connection with the method according to the invention. In the present case, reference to these advantages is made in full.

### BRIEF DESCRIPTION OF THE DRAWINGS

The invention and the embodiments, as well as the advantages thereof, are explained in further detail hereinafter with reference to the drawings. Schematically shown are:

FIG. 1 a schematic illustration of a fuel cell system,

FIG. 2 a schematic illustration of a fuel cell system,

FIG. 3 a schematic illustration of an intermittent exhaust gas recirculation, and

FIG. 4 a schematic illustration of an intermittent exhaust gas recirculation.

### DETAILED DESCRIPTION

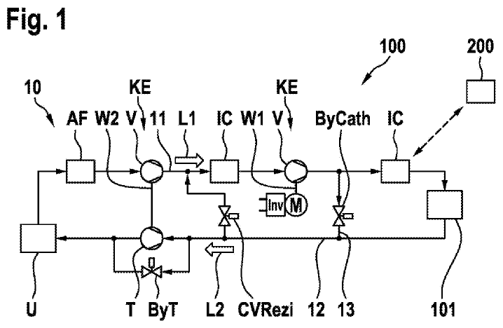

FIGS. 1 and 2 each show a fuel cell system 100 within the meaning of the invention.

The fuel cell system 100 within the meaning of the invention comprises the following elements:
at least one fuel cell stack 101, and
a cathode system 10 for supplying a reactant containing oxygen to the at least one fuel cell stack 101 in the form of supply air L1,
whereby the cathode system 10 comprises the following components:
(at least) one supply air line 11 for providing supply air L1 to the at least one fuel cell stack 101
and (at least) one exhaust line 12 for discharging exhaust air L2 from the at least one fuel cell stack 101,
whereby a compression unit KE is provided in the (at least one) supply air line 11 for compressing supply air L1,
whereby an air connection LV is provided between the (at least one) exhaust line 12 and the (at least one) supply line 11 from one exhaust L2 to one supply air L1 (from one stack_i to the same stack_i, from stack_i to another stack_k, from multiple stacks_i,j to one and/or multiple same or different stacks_k,m, whereby i, je k can be the same or different counters),
and whereby the air connection LV is used to provide intermittent exhaust gas recirculation EGR into the supply air L1 in at least one operating mode M of the fuel cell system 100.

The fuel cell system 100 can be used for mobile applications, such as in motor vehicles, or for stationary applications, such as in generator systems. The fuel cell system 100 according to the present invention can comprise at least one or multiple fuel cell stacks 101, which can be simply referred to as stacks, each having stacked repeat units in the form of a plurality of fuel cells 101, e.g. PEM fuel cells.

The fuel cell system 100 therefore comprises a cathode system 10 with a supply air line 11 to the stack 101 and an exhaust air line 12 from the stack 101. At least one air filter AF is arranged at the entry of the supply air line 11 in order to filter harmful chemical substances and particles or to prevent their entry into the system 100.

The compression unit KE in the cathode system 10 is used to draw in the air from the surrounding environment and supply it to the stack 101 in the form of supply air L1. After passing through the stack 101, exhaust air L2 is discharged from the stack 101 back into the surrounding environment U.

The compression unit KE can have at least one compressor V operated by an electric motor (cf. FIG. 1, right and FIG. 2, left) and/or at least one mechanically operated compressor V, particularly one using a turbine T (cf. FIG. 1, left and FIG. 2, right) and/or at least one compressor operated using an electric motor and mechanical (not shown only for reasons of simplicity), in particular with the help of a turbine, in the supply air line 11.

In addition, the compression unit KE can comprise at least one turbine T in the exhaust line 12, which is arranged in an operative connection with at least one compressor V in the supply air line 11 to support the at least one compressor V in compressing the supply air L1.

As indicated by FIGS. 1 and 2, at least one or multiple IC supply air coolers can be provided downstream of the compression unit KE. Optionally, a heat exchanger and/or a humidifier can be provided in the context of the cathode system 10, which are not shown for reasons of simplicity only.

Shut-off valves can be provided upstream and downstream of the fuel cell stack or stack 101 (not shown simply for reasons of simplicity).

In addition, a valve CVexh can be provided as a pressure regulator in the exhaust air line 12.

A bypass line 13 comprising a ByCath bypass valve can be provided between the supply air line 11 and the exhaust air line 12.

The air connection LV in the scope of the invention can preferably comprise a line between the exhaust line 12 and the supply air line 12 as well as a recirculation valve CVRezi.

Exhaust gas recirculation within the scope of the invention can be abbreviated as EGR.

The invention proposes an intermittent operational strategy for exhaust gas recirculation, which can be advantageous, for example, in a continuous high-load range, but also in other load ranges of the fuel cell system 100.

The intermittent exhaust gas recirculation can provide for variable activation of different operating parameters of the fuel cell system 100, in particular of the cathode system 10. The intermittent exhaust gas recirculation can further optionally be combined with corresponding activation of an anode system and/or cooling system.

Using intermittent exhaust gas recirculation, it can be ensured that the at least one fuel cell stack 101:
neither dries out (in the entry areas of the stack cathode) nor
is flooded (near or at the exit areas of the stack cathode)
and can continuously produce the high load or maximum load.

In particular, the following (other optional) parameters can be varied:
cathode pressure pCath,
cathode mass flow rate mCath,
cathode outlet activity aCath and
EGR recirculation rate (thus also cathode inlet moisture).

Multiple advantages can be achieved using the invention:
(at least temporary) humidification of the supply air L1 at the entry to the stack 101, without a loss of power or derating,
(at least temporarily) improving the removal of water from the outlet from stack 101,
(at least temporary) oxygen depletion in the stack 101,
improvement in the service life of the stack 101,
decrease in stack degradation (less drying, etc.)
cost savings in the design of the system 100, etc.

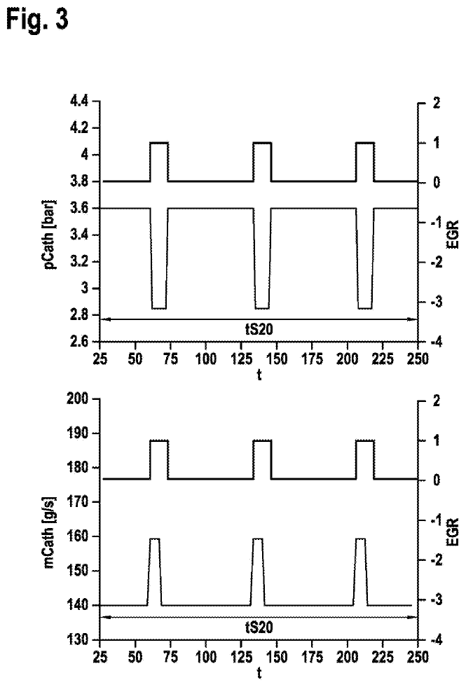

As FIG. 3 suggests, intermittent exhaust gas recirculation can be advantageous for high load operation, particularly continuous high-load operation, (e.g., 50%-100%, in particular 75%-100%, or even 80%-100% of maximum power) and/or maximum load operation of the fuel cell system 100. The term “continuous” can mean that the system is subject to a high load or a maximum load request to the fuel cell system 100 for long enough that:
purely stack-internal humidification can no longer be maintained and/or
this use case would already lead to a more costly design (enlargement of the stack 101 or the cathode system 10) during development.

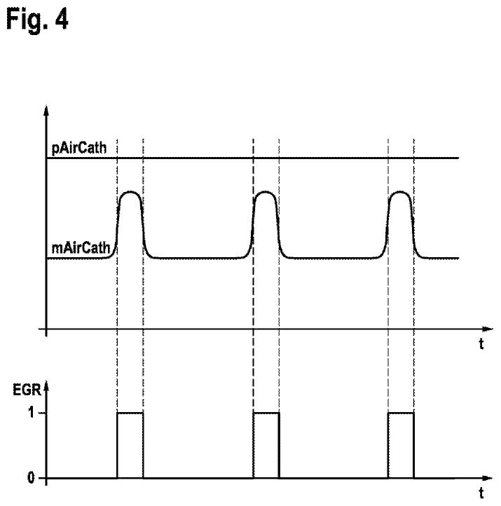

As indicated in FIG. 4, intermittent exhaust gas recirculation can be advantageous at low loads, for example, when the supply air mass flow rate mCath is low enough that the discharge of water from stack 101 is insufficient, and that there is a risk of liquid water accumulating in stack 101 or flooding the stack 101. If the mass flow rate of the fresh air is increased, however, the oxygen in the cathode can also increase, which can no longer be suitable for power and water management. Using intermittent exhaust gas recirculation, the discharge of water from the stack 101 can be permitted, preferably without the stack simultaneously increasing the oxygen mass in the cathode path. In this respect, the cathode pressure pStack can advantageously be kept substantially constant, as shown schematically in FIG. 4.

During normal operation, initially only in-stack humidification can be performed without intermittent exhaust gas recirculation. If high ambient temperatures prevail during normal operation (resulting in high stack temperatures), but the temperature difference to the surrounding environment is still sufficient to sufficiently remove the waste heat from the stack, then the stack must be operated at high pressure pCath1 and low combustion air ratio lambdaCath1 (or lambda, also abbreviated as γ or referred to an air ratio or air count, and superstoichiometrically expressed as mCathStack=lambda*mCathStoechiometric) in order to maintain in-stack humidification.

In this case, the entry/initial areas of the stack cathode may run the risk of drying out after a certain time td1.

The output/end areas of the stack cathode may in turn run the risk of partial flooding due to high water production at high load after a certain time td2.

Both of the above effects can lead to performance declines and, in some cases, degradation of the stack 101. Advantageously, intermittent exhaust gas recirculation can be initiated after a time tS10=min(td1, td2).

Intermittent exhaust gas recirculation can preferably comprise in-stack humidification and additionally exhaust gas recirculation.

Intermittent exhaust gas recirculation can then be initiated or triggered when the time tS10=min(td1, td2) has elapsed.

Advantageously, intermittent exhaust gas recirculation causes no, or at least no substantial, reduction in performance.

A CVRezi recirculation valve can be opened in the partial position to introduce a portion of the exhaust air into the supply air for intermittent exhaust gas recirculation.

As FIG. 3 suggests, the cathode pressure pStack can be lowered to pCath2 and the mass flow rate mCath can be increased to mCath2. The activity at the cathode outlet actCath2 also temporarily increases. In other words, the air in the cathode removes more water, and humidification of the supply air L1 is improved. By increasing the mass flow rate mCath in the stack 101, the water in the output/end areas is conveyed out better, meaning that the risk of flooding is significantly reduced.

The increased mass flow rate mCath advantageously does not increase the lambda, because the supplied exhaust air L2 is lower in oxygen than the air mass flow from the surrounding environment U. The lambda can preferably be kept approximately constant, if, for example, the cathode system 10 additionally increases the supply air quantity somewhat. This is possible even if the cathode system 10 no longer has a rotational speed reserve because, by decreasing the system pressure pCath, the cathode system 10 can deliver a greater mass flow rate mCath at the same rotational speed. Alternatively or additionally, a rotational speed reserve can be provided in the cathode system 10.

By humidifying the supply air L1 using the intermittent exhaust gas recirculation, the entry areas of the stack 101 in particular can be significantly humidified so that the risk of the membrane drying in the stack 101 can be significantly reduced.

The intermittent exhaust gas recirculation can be performed for a certain time tS20. The time tS20 can vary depending on various effects, such as humidification at the cathode inlet tx1, reduction in flooding tx2, optionally permissible duration of lambda decrease tx3, e.g. tS20=min(max (tx1,tx2), tx3).

The intermittent exhaust gas recirculation can use different types of activation (different times on or off, different gradients, etc.). Different types of activation can be determined individually, depending on the system, and/or depending on design, and/or operating conditions, and/or depending on boundary conditions.

Also, the essential parameters can be adjusted constantly or variably during the phases (intermittent exhaust gas recirculation on and off).

Intermittent exhaust gas recirculation can continue to be performed proactively using, e.g., trajectory planning and/or as a function of weather data, navigational data, performance trajectories, etc.

Advantageously, intermittent exhaust gas recirculation EGR can be initiated when:
internal humidification of the at least one fuel cell stack 101 is not sufficient,
entry areas/initial areas of the at least one fuel cell stack 101 dry out or are likely to be at risk of drying out, particularly after a certain time dt1, and/or
output areas/end areas of the at least one fuel cell stack 101 can be flooded or are likely to be flooded, particularly after a certain time dt2,
in the case of longer exposure to high-load requirements on the at least one fuel cell stack 101,
whereby in particular a stack voltage and/or single cell voltages and/or impedance are measured to detect the state of the fuel cell stack (101) and/or a potential for danger, drying, flooding, etc. in the fuel cell stack (101),
oxygen depletion, at least on a temporary basis, is required in the at least one fuel cell stack 101.

According to a further advantage, intermittent exhaust gas recirculation can be performed repeatedly and/or regularly, and/or due to specific events and/or periodically. In this way, flexible as well as extended functionality can be provided.

The description hereinabove of the drawings merely describes the present invention by way of example. Of course, individual features of the embodiments can be freely combined with one another, insofar as technically sensible, without leaving the scope of the invention.

1. A method for operating a fuel cell system (100),
wherein the fuel cell system (100) comprises the following components:
at least one fuel cell stack (101), and
a cathode system (10) for supplying a reactant containing oxygen to the at least one fuel cell stack (101) in the form of supply air (L1),
wherein the cathode system (10) comprises the following components:
at least one supply air line (11) for supplying supply air (L1) to the at least one fuel cell stack (101)
and at least one exhaust line (12) for discharging exhaust air (L2) from the at least one fuel cell stack (101),
wherein a compression unit (KE) is provided in the at least one supply air line (11) for compressing supply air (L1),
wherein an air connection (LV) is provided from an exhaust air (L2) to supply air (L1) between the at least one exhaust line (12) and the at least one supply air line (11),
and wherein the air connection (LV) is used to provide intermittent exhaust gas recirculation (EGR) into the supply air (L1) in at least one operating mode (M) of the fuel cell system (100).

2. The method according to claim 1,
wherein
the intermittent exhaust gas recirculation (EGR) is performed during high-load operation and/or a maximum load operation of the fuel cell system (100),
to humidify the supply air (L1).

3. The method according to claim 1,
wherein
the intermittent exhaust gas recirculation (EGR) is used to increase a mass flow rate (mCath) through the at least one fuel cell stack (101),
to support the removal of water from the fuel cell stack (101),
without increasing the oxygen mass in the at least one fuel cell stack (101),
without altering a cathode pressure (pCath),
and/or in that the intermittent exhaust gas recirculation (EGR) is utilized to deplete a mass flow rate (mCath) of oxygen through the at least one fuel cell stack (101).

4. The method according to claim 1,
wherein
the intermittent exhaust gas recirculation (EGR) provides an opening of a recirculation valve (CVRezi).

5. The method according to claim 1,
wherein
the intermittent exhaust gas recirculation (EGR) performs variable activation of at least one operating parameter (BP) of the fuel cell system (100), based on the following parameters:
a rate of recirculation from the exhaust air (L2) to the supply air (L1),
cathode mass flow rate,
cathode pressure, and/or
cathode activity.

6. The method according to claim 5, wherein
the intermittent exhaust gas recirculation (EGR) provides for periodic or aperiodic and/or symmetric or asymmetric activation of at least one operating parameter (BP) of the cathode system (10).

7. The method according to claim 1, claims,
wherein
the intermittent exhaust gas recirculation (EGR) is initiated when:
internal humidification of the at least one fuel cell stack (101) is not sufficient, and/or
entry areas/initial areas of the at least one fuel cell stack (101) dry out or are likely to be at risk of drying out, and/or
output areas/end areas of the at least one fuel cell stack (101) can be flooded or are likely to be flooded, and/or
longer exposure to high-load requirements on the at least one fuel cell stack (101) occurs, and/or
oxygen depletion is required in the at least one fuel cell stack (101).

8. The method according to claim 1,
wherein
the intermittent exhaust gas recirculation is performed repeatedly, and/or regularly, and/or due to specific events, and/or periodically,
and/or that the intermittent exhaust gas recirculation is performed proactively, as a function of weather data and/or navigation data, and/or as a function of predictive performance trajectories.

9. A non-transitory, computer-readable medium containing instructions that, when executed by a computer, cause the computer to control a fuel cell system (100),
wherein the fuel cell system (100) comprises the following components:
at least one fuel cell stack (101), and
a cathode system (10) for supplying a reactant containing oxygen to the at least one fuel cell stack (101) in the form of supply air (L1),
wherein the cathode system (10) comprises the following components:
at least one supply air line (11) for supplying supply air (L1) to the at least one fuel cell stack (101)
and at least one exhaust line (12) for discharging exhaust air (L2) from the at least one fuel cell stack (101),
wherein a compression unit (KE) is provided in the at least one supply air line (11) for compressing supply air (L1),
wherein an air connection (LV) is provided from an exhaust air (L2) to supply air (L1) between the at least one exhaust line (12) and the at least one supply air line (11),
and wherein the air connection (LV) is used to provide intermittent exhaust gas recirculation (EGR) into the supply air (L1) in at least one operating mode (M) of the fuel cell system (100).

10. (canceled)

11. A fuel cell system (100),
wherein the fuel cell system (100) comprises the following components:
at least one fuel cell stack (101), and
a cathode system (10) for supplying a reactant containing oxygen to the at least one fuel cell stack (101) in the form of supply air (L1),
wherein the cathode system (10) comprises the following components:
a supply air line (11) for supplying supply air (L1) to the at least one fuel cell stack (101),
and an exhaust line (12) for discharging exhaust air (L2) from the at least one fuel cell stack (101),
wherein a compression unit (KE) is provided in the (at least) one supply air line (11) for compressing supply air (L1),
wherein an air connection (LV) is provided from an exhaust air (L2) to supply air (L1) between the at least one exhaust line (12) and the at least one supply air line (11),
and wherein the air connection (LV) is designed to provide intermittent exhaust gas recirculation (EGR) into the supply air (L1) in at least one operating mode (M) of the fuel cell system (100).

12. The fuel cell system (100) according claim 11, further comprising:
a control unit (200) at least one compressor (V1, V2).
